(19) United States
(12) Patent Application Publication
(10) Pub. No.: US 2006/0235953 A1
(43) Pub. Date: Oct. 19, 2006

(54) Systems and methods for installing, configuring, and supporting computer networks

(75) Inventor: Keith R. Meier, Acworth, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Assurant Solutions

(21) Appl. No.: 11/263,588

(22) Filed: Oct. 31, 2005

Related U.S. Application Data
(60) Provisional application No. 60/623,982, filed on Oct. 31, 2004.

(51) Int. Cl. G06F 15/177

(52) U.S. Cl. 709/220

(57) ABSTRACT

A computer networking package that, in various embodiments, comprises: (1) networking software that installs, configures, and manages a home networking system; and (2) a service contract for providing phone or Internet-based technical support for the software and/or hardware used in the home networking system. In various embodiments, the networking software provides: (1) a wizard-based point/click tutorial for setting up a wired and/or wireless home network, (2) automatic configuration of the network for the sharing of documents, files, folders, photos, hard drives, and/or printers between computers within the home network, (3) local, offline technical support to allow customers to protect and restore the network's settings, internet browsers, and email programs, (4) a URL for connection to live technical assistance, e.g., via the Internet, and/or (5) an Internet connection and software required for the installation and set-up of the home network.

### CROSS REFERENCE TO RELATED APPLICATION

This application claims the benefit of U.S. Provisional Application Serial No. 60/623,982, which was filed on Oct. 31, 2004, and which is hereby incorporated herein by reference in its entirety.

### BACKGROUND OF THE INVENTION

Installation difficulties have been a major obstacle to the broad-based adoption of home computer networks, both wired and wireless. The relevant official communication standards and certifications are still evolving as new equipment is developed. Interoperability between and among various components continues to present a challenge. The convenience of wireless networking is attractive, but many consumers are dissuaded by the technical challenges expected during installation.

Wireless fidelity or Wi-Fi® refers generally to a wireless, local area network of computers. Wireless products communicate generally using a particular radio frequency, which can vary depending on the hardware specifics, the manufacturer, and the communication standards in effect when the product was designed. The variety of products available, when used together to build a wireless network, often produces a multitude of compatibility and interoperability problems, some of which can lead to the failure of costly components. Using products by different manufacturers also prevents the user from contacting a single source for technical support or troubleshooting. Accordingly, there is a need for improved network installation and support products.

### SUMMARY OF THE INVENTION

A computer networking package according to one embodiment of the invention comprises: (1) networking software that installs, configures, and manages a home networking system; and (2) a service contract for providing (e.g., phone or Internet-based) technical support for the software and hardware used in the home networking system. The package preferably is configured for use within the context of a home computer network. However, in alternative embodiments the package may be configured for use within other types of networks, such as office networks.

In one embodiment, the networking software provides: (1) a wizard-based point/click tutorial for setting up a wired and/or wireless home network, (2) automatic configuration for the sharing of documents, files, folders, photos, hard drives, and/or printers between computers within the home network, (3) local, offline technical support to allow customers to protect and restore the network's settings, internet browsers, and/or email programs, (4) a URL for connection to live technical assistance, e.g., via the Internet, and/or (5) an Internet connection and software required for installation and set-up of the home network.

In a particular embodiment, the service contract provides around-the-clock technical support via telephone or the Internet. In one embodiment, the service contract includes support for both the software program used to set up the network and one or more hardware components used within the network. In a particular embodiment, the service contract also provides mechanical breakdown coverage for various network components. The service provider may limit the number of computers that are supported under the service contract (e.g., to two or three computers). However, in some cases, the customer may add additional hardware to the contract for an additional fee.

### SUMMARY OF SELECTED EXEMPLARY CONCEPTS

The following is a summary of several selected concepts according to various embodiments of the invention:

(1) A combined software and hardware support contract that provides both technical support for one or more (and preferably all) of the software and hardware components of a home computer network, and mechanical breakdown coverage for some or all of the hardware components within the home computer network. In one embodiment, the mechanical breakdown coverage covers two computers, two modems, two network routers, and two PC network cards. In a further embodiment, coverage for additional equipment may be purchased by the customer for an additional fee.

(2) An automated system (e.g., in the form of a software package) for installing a home networking system. The system guides customers through the installation process and automatically configures the home networking system to share documents, files, folders, hard drives, and/or printers.

(3) A self-service support portal that: (A) substantially automatically gathers network system information for troubleshooting; (B) provides automated and/or semi-automated tutorials and/or answers to FAQ's regarding a network system; (C) provides games to be played over the network; (D) provides personalized software updates for hardware components within the network; (E) provides “one-click fixes” to network problems; and/or (F) provides one or more software wizards for addressing common network issues.

(4) A home network installation system that automatically or substantially automatically installs and configures one or more games to be played over a computer network by two or more players on separate computers within the computer network.

(5) A home network installation system that automatically or semi-automatically installs and configures both wired and wireless networking software.

(6) A home networking system that automatically detects hardware to be used within a home network and configures the hardware to operate within the network.

### BRIEF DESCRIPTION OF THE DRAWINGS

Having thus described the invention in general terms, reference will now be made to the accompanying drawings, which are not necessarily drawn to scale, and wherein:

FIG. 1 is a graphical depiction of a networking product according to a particular embodiment of the invention.

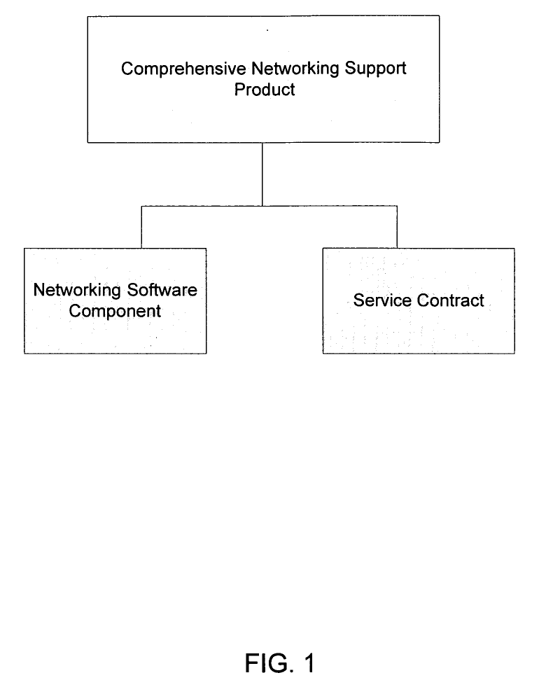

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements.

Home Networking Solution: In one embodiment, the present invention provides a home computer networking package that may include a software component and a service contract. The software component may include software for installing, configuring, and managing a home networking system. The service contract may include the provision of (e.g., telephone or Internet-based) technical support for the software and/or the hardware used in the home networking system. The service contract may also include insurance coverage that provides coverage for the mechanical failure of one or more (and preferably substantially all) of the network's various components.

The home networking software program may be configured to provide: (a) a wizard-based point-and-click tutorial for automatically installing and setting-up a wired or wireless home network that guides the user through the process, step by step; (b) automatic configuring of system components to enable and facilitate the sharing of documents, files, folders, photos, hard drives, and printers between and among computers within a network; (c) local, offline technical support to allow customers to protect and restore the network settings, internet browsers, and e-mail programs; (d) a URL for connection to live technical assistance via the Internet; and/or (e) an Internet connection including the software required for installation and set-up.

In one embodiment, the home network installation system may automatically detect the presence and identity of the hardware to be used within the network, and then configure the hardware to operate properly and efficiently within the network.

In one embodiment, the home network installation system may install and configure networked games to be played by two or more players over the network using separate computers on the network.

The service contract may provide around-the-clock technical support via telephone or the Internet for enrolled customers. The service contract may include support for both the software programs and the hardware within the network. The service provider may limit the number of computers that are supported under the service contract. In one embodiment, the customer may add additional hardware to the contract for an additional fee.

The technical support, in one embodiment, may include a self-service Internet-based support portal. The portal may be configured to automatically gather information from the network for troubleshooting purposes. The network may also provide automated and semi-automated tutorials, FAQ answers, games compatible for play within the network, personalized updates based on the user's particular system, “one-click fixes” to common problems, and/or software wizards for addressing common network issues.

Equipment Protection. The service contract may also provide mechanical breakdown coverage for various network components. This coverage may be provided, for example, in the form of an insurance contract. The insurance offered may include coverage for any number of computers, modems, routers, network cards, or other hardware within, or related to, a network. In one embodiment, the insurance may cover two computers, two modems, two network routers, and/or two PC network cards, with coverage for additional equipment available for an additional fee.

In various embodiments, by reducing the potential out-of-pocket cost of component failure, various embodiments of the present invention also reduce the risk of component failure to an acceptable level, and thereby allow the consumer to more comfortably undertake the installation and configuring of a home network.

The Support Bundle. In one embodiment, the present invention offers a unique combination of installation software, technical support, and equipment protection in a single product, from e.g., a single source. By bundling the services together, in one embodiment, the present invention unifies the entire support structure from installation through normal operations, and during failures should they occur, without requiring the consumer to seek assistance from various manufacturers.

In another aspect, the bundling of services may provide a benefit to the service provider because the service elements—installation, support, protection—are mutually interdependent and developed by the service provider. For example, the installation software may be designed and maintained by the service provider, thereby making technical support functions easier to accomplish. There may be a large base of knowledge about how the software was installed and how it functions. In another aspect, the technical support function may provide assistance when a user reports a suspected mechanical failure of a hardware component. Because the service provider receiving the reported failure may also provide technical support, the relevant technical support personnel may discover that the hardware has not actually failed and may be able to resolve the problem without replacing the hardware. This may serve to avoid an unnecessary claim under the equipment protection portion of the service contract.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1. A networking product for use in conjunction with a computer network, the networking product comprising: a networking software component, and a service contract.

2-26. (canceled)

27. A networking product for use in conjunction with a computer network, the networking product comprising: a networking software component and a service contract, wherein:
said networking software component is configured for establishing said computer network in a substantially automated manner; and
said service contract provides insurance coverage for one or more computers within said computer network.

28-30. (canceled)
